(19) United States
(12) Patent Application Publication
(10) Pub. No.: US 2014/0335908 A1
(43) Pub. Date: Nov. 13, 2014

(54) MANAGEMENT OF CONVERSATION CIRCLES FOR SHORT-RANGE AUDIO COMMUNICATION

(71) Applicant: Bose Corporation, Framingham, MA (US)

(72) Inventors: Kathleen S. Krisch, Sudbury, MA (US); Naganagouda B. Patil, Ashland, MA (US); Steven H. Isabelle, Newton, MA (US)

(73) Assignee: Bose Corporation, Framingham, MA (US)

(21) Appl. No.: 13/890,350

(22) Filed: May 9, 2013

(51) Int. Cl. H04W 4/08

(52) U.S. Cl. CPC H04W 4/08
USPC 455/518

(57) ABSTRACT

An apparatus for managing communication between headsets includes a first headset having a microphone, at least one earphone, and a wireless interface for voice and data communication with other headsets. The headset is distinguished from other headsets by a first identification code. The apparatus also includes a controller configured for recognizing a set of identification codes broadcast by the other headsets and causing the first headset to establish communication with headsets having identification codes selected from the set of identification codes.

### FIELD OF DISCLOSURE

This disclosure relates to voice communication networks, and in particular, to management of connectivity between nodes of such a network.

### BACKGROUND

In many places, high levels of ambient noise may hamper face-to-face conversations. For example, in some restaurants, where many people talk at the same time, it can be too loud to easily conduct a conversation. Nightclubs and bars may have loud music in the background. Airplanes and trains have high ambient noise levels from operation of machinery. In such environments, it is difficult to maintain a conversation between two people, and even more difficult to maintain a conversation between more than two people.

A known method of overcoming the foregoing difficulty includes simply increasing the volume of one's own voice. This enables one to be heard more easily. However, doing so for extended periods strains the voice and results in hoarseness. In addition, it is difficult to communicate with nuance and subtlety when the dynamic range of one's voice is constrained by the need to exceed a threshold minimum. Finally, in some places the ambient noise level is so high that it is simply not possible to raise one's voice to a volume that is sufficient to be heard over the ambient noise.

Another method of overcoming the difficulty is to reduce the distance between the speaker and the listener. However, this method is not scalable. When more than two or three people are in a conversation, it becomes physically difficult to position them closely enough to converse in a noisy environment.

### SUMMARY

In one aspect, the invention features an apparatus for managing communication between headsets. Such an apparatus includes a first headset having a microphone, at least one earphone, and a wireless interface for voice and data communication with other headsets. The headset is distinguished from those other headsets by a first identification code. The apparatus further includes a controller configured for recognizing a set of identification codes broadcast by the other headsets and causing the first headset to establish communication with headsets having identification codes selected from the set of identification codes.

In some embodiments, the identification code is a permanent feature of the headset.

In other embodiments, the wireless interface is capable of periodically broadcasting information representative of its presence and status, and negotiating connections with other headsets.

Also among the embodiments are those in which the controller is configured to provide the identification code to the headset.

Other embodiments include those in which the controller is further configured to receive the set of identification codes, to map at least some of the identification codes from the set of identification codes to persons, to display, based on the at least some of the identification codes, data representative of persons with which communication is available, to accept input defining a selection from the data representative of persons with which communication is available, a set of persons defining a conversation circle of persons with which communication is to be established, and to respond to receiving the data representative of identification codes defining the conversation circle by establishing communication with headsets identified by the identification codes. In some of these embodiments, the controller is further configured for receiving instructions to solicit, from members of a conversation circle, permission to join the conversation circle. In others, the controller is configured to respond to receiving the data representative of identification codes defining the conversation circle by instructing the headset to establish communication with headsets identified by the identification codes.

Among the other embodiments are those in which the controller is further configured to display a user interface showing icons available for joining a conversation circle. Among these are embodiments in which the icon represents a person and other embodiments in which the icon represents another conversation circle. Also among these are embodiments in which the controller is further configured to receive an input identifying one of the icons for inclusion in a conversation circle.

Also among the embodiments are those in which the controller is further configured to cause suppression of broadcast of the identification code.

In some embodiments, the controller is implemented as software on a touch-screen equipped portable device. Among these are embodiments in which the software for implementing the controller is part of an operating system of the portable device and embodiments in which the software for implementing the controller is an application executing on the portable device.

Yet other embodiments include those in which the headset is configured to establish communication with a touch-screen equipped portable device on which the controller is implemented.

Also among the embodiments are those in which the controller is implemented on a computer-readable medium that is partly in a touch-screen equipped portable device and partly in the headset, and those in which the controller is implemented in the headset.

Other embodiments include those that further include a touch-screen equipped portable device in communication with the headset, wherein the controller is implemented on the touch-screen equipped portable device.

Also included are embodiments that include any combination of the foregoing features and any combination of two or more of the foregoing embodiments.

In another aspect, the invention features a method for managing wireless communication between headsets. Such a method includes displaying information identifying headsets available for communication, receiving instructions identifying a subset of the headsets, and establishing communication with the subset of headsets to the exclusion of headsets not in the subset of headsets.

In some practices, the subset defines an active conversation circle. Among these are practices in which issuing a request to join the active conversation circle, and receiving approval of the request and practices that further include suppressing broadcast of information identifying an active conversation circle to all but members of the active conversation circle.

Other practices further include suppressing broadcast of information identifying a headset.

Also included are practices that include any combination of the foregoing features and any combination of two or more of the foregoing practices of the invention.

In another aspect, the invention features a method for managing wireless communication between headsets. Such a method includes establishing communication with a plurality of headsets, thereby defining a first conversation circle of headsets, receiving, from a first entity, a request to join the first conversation circle, approving the request, and establishing communication between the first entity and the plurality of headsets, thereby adding the first entity to the first conversation circle.

Among these are practices in which the first entity includes an individual headset, and those in which the first entity includes a plurality of headsets that have established communication between each other, thereby forming a second conversation circle, and wherein establishing communication between the first entity and the plurality of headsets includes merging the first and second conversation circles.

Other practices include suppressing broadcast of information identifying a headset.

Also included are practices that include any combination of the foregoing features and any combination of two or more of the foregoing practices of the invention.

In another aspect, the invention includes a manufacture including a non-transitory computer-readable medium having encoded thereon software for managing communication between headsets, each of which has a microphone, at least one earphone, and a wireless interface for voice communication with other headsets, each of the headsets being distinguished from other headsets by an identification code, the software including instructions for causing recognition of a set of identification codes broadcast by headsets from a set of headsets, and for causing establishment of duplex voice communication with a subset of the set of headsets, the subset consisting of headsets having identification codes selected from the set of identification codes. Among these embodiments are those in which the computer-readable medium is part of a touch-screen equipped portable device and those in which the computer-readable medium is part of a headset.

Also included are manufactures that include any combination of the foregoing features and any combination of two or more of the foregoing embodiments of the invention.

These and other features of the invention will be apparent from the following detailed description and the accompanying claims, in which:

### BRIEF DESCRIPTION OF THE FIGURES

FIG. 1 shows a headset;

FIGS. 2 and 3 show other headsets in communication with the headset of FIG. 1; and

FIG. 4 shows a user-interface controlling communication between the headsets in FIG. 2.

### DETAILED DESCRIPTION

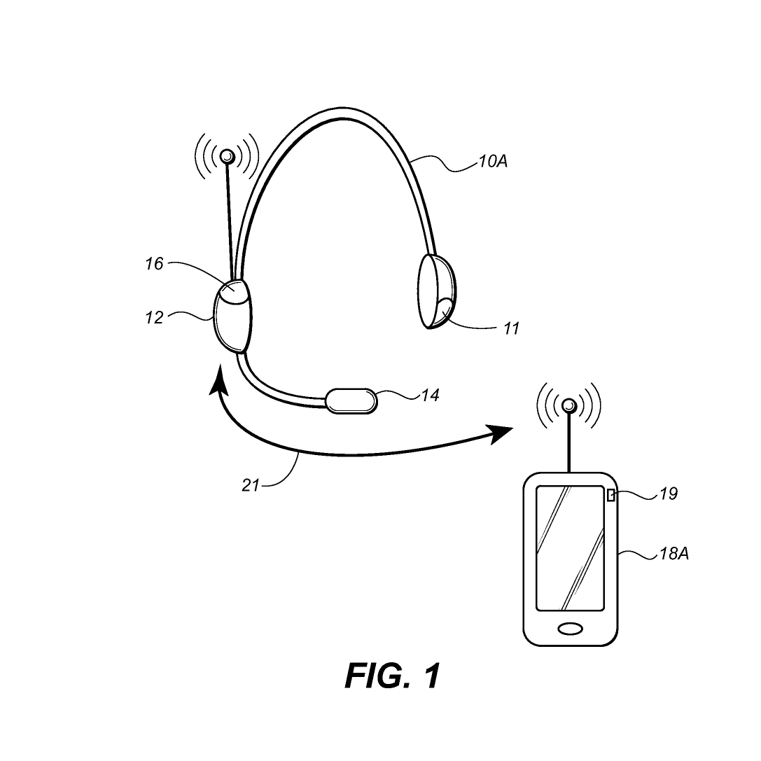

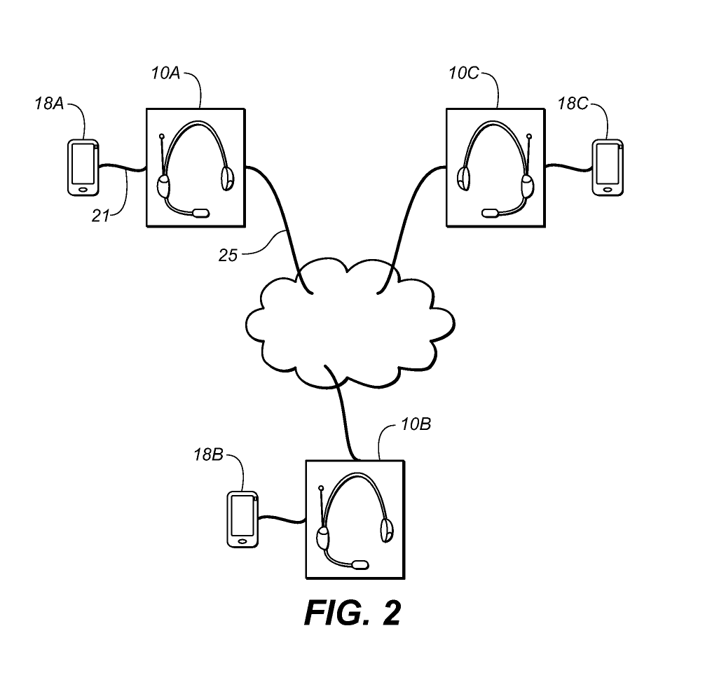

FIG. 1 shows a headset 10A to be used by a person who wishes to communicate. The headset 10A includes earpieces 12, a microphone 14, and a high-bandwidth wireless interface 16 to enable communication with other headsets 10B, 10C nearby, as shown in FIG. 2. As used herein, a high-bandwidth wireless interface is one that is configured to achieve a communication rate sufficient for voice communication. In a typical embodiment, this requires a bandwidth of at least 16 Kb/sec. The wireless interface 16 may also be configured to exchange identification and control signals with other headsets nearby.

Each headset 10A has an identification code to distinguish it from other headsets 10B, 10C. In addition, each headset 10A includes computer-readable instructions 11 configured to recognize identification codes from nearby headsets 10B, 10C and to enable or disable communication with selected headsets 10B. As used herein, two headsets 10A, 10B are “nearby” if they are able to establish direct communication with each other.

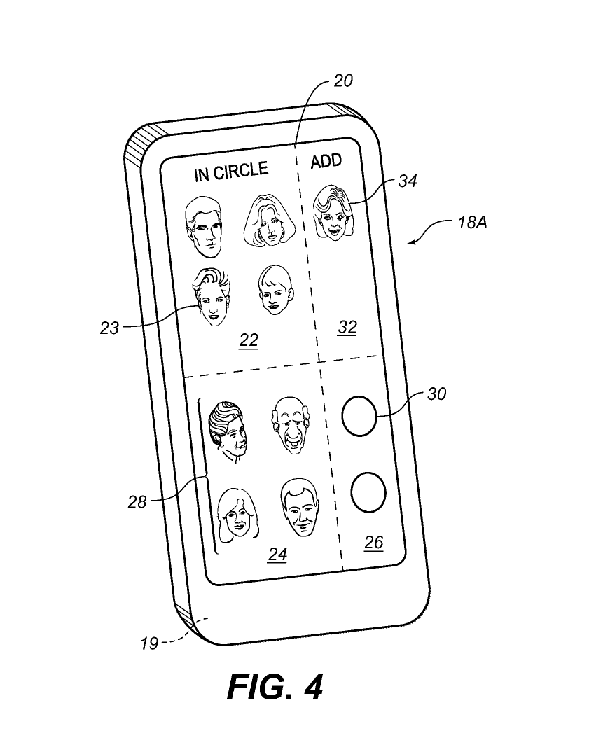

The headset 10A communicates with a smart phone, tablet, or other device with a touch-screen interface 18A that executes software 19 for transmitting identification information and receiving identification information associated with nearby headsets 10B, 10C and displays that identification information to the user. This results in a listing of available communicants 28, shown in FIG. 4. These available communicants 28 have similarly equipped headsets 10B, 10C and smart phones 18B, 18C, as shown in FIG. 2.

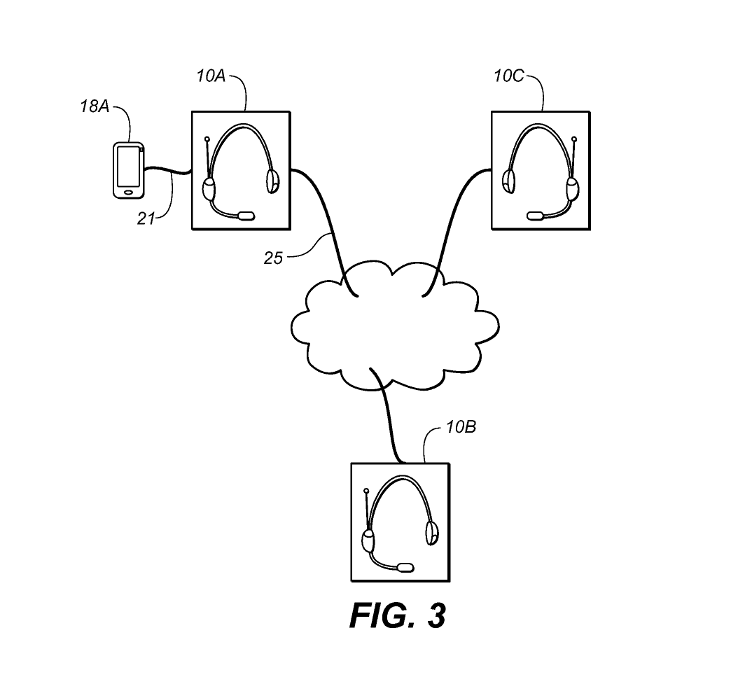

In the particular embodiment shown herein, the software 19 and the computer-readable instructions 11 collectively define a controller configured for transmitting identification codes, recognizing a set of identification codes broadcast by the other headsets and causing the first headset to establish communication with headsets having identification codes selected from the set of identification codes. Such a controller can be implemented as shown, partly in a smart-phone 18A and partly in the headset 10A. However in alternative embodiments, the controller is implemented as software or firmware entirely in the headset 10A or as firmware or software entirely in the smart-phone 18A. In general, not all communicants are required to have the same embodiment. For example, a communicant having a controller implemented as shown, partly in a smart-phone 18A and partly in the headset 10A, can readily communicate with one having an embodiment in which the controller is implemented as software or firmware entirely in the headset 10A, as shown in FIG. 3.

The smart phone 18A and headset 10A communicate via a first link 21. In some embodiments, the first link 21 is a wire connection. However, in other embodiments, the first link 21 is a wireless link using a suitable protocol, such as BLUETOOTH™. This connection is used to enable the one of the smart phone 18A and the headset 10A to communicate instructions and authorization codes identifying those available headsets 10B with which a high bandwidth wireless connection 25 is to be established, such as between smart phones 18A, to 18B and 18C in FIG. 2, or between headsets 10A to 10B and 10C in FIG. 3. The set of all such headsets defines a first active conversation circle as described below.

FIG. 4 shows a typical user-interface 20 provided by the software 19 for display on the smart-phone 18A. The user-interface 20 features a first region 22 showing icons representative of members of a first active conversation circle 23, a second region 24 showing icons representative of nearby prospective communicants 28, a third region 26 showing icons representative of one or more nearby second active conversation circles 30, and a fourth region 32 showing icons representative of people who are candidates for addition 34 to the first active conversation circle 23 shown in the first region 22. Software 19 for generating the user-interface 22 as shown in FIG. 4 and managing communication can be implemented as an application on such a smart phone 18A. Alternatively, such software 19 can be implemented directly in firmware of the smart phone 18A.

Each smart phone 18A or headset 10A periodically broadcasts its presence and status. Since this broadcast is a recurring one, it is preferably carried out using a low-energy protocol to avoid excessive battery drainage. A suitable protocol for such use is the Bluetooth Low-Energy (BTLE) protocol.

Using the user-interface 20 shown in FIG. 4, the user identifies, from the available communicants 28 shown in the second region 24, one or more prospective communicants with whom he wishes to communicate. Having done so, he issues an invitation. This can be done by keying in the name of the prospective communicant or by performing some gesture that involves the display of the prospective communicant. Such a gesture may include tapping the prospective communicant's icon or dragging it to the fourth region 32.

Upon doing so, an invitation is displayed on the candidate communicant's user-interface 20. The display may be a window with buttons for accepting or declining the invention.

If the candidate communicant accepts the invitation, a two-way voice link 25 is established between the two headsets 10A, 10B using their respective high-bandwidth wireless interfaces 16. This procedure is repeated for other candidate communicants as necessary. The icons representing these communicants are then moved to the first region 22 to indicate that they are now members of the first active conversation circle 23. Within the first active conversation circle 23, all communicants can talk to each other using the headsets 10A-10C just as if they were in a conference call.

The process of adding communicants to the first active conversation circle 23 is a dynamic one. For example, if after a first active conversation circle 23 is established, a new person comes within range of a wireless interface, his icon will appear in the second region 24. Any member of the first active conversation circle 23 may then issue an invitation to the newcomer to join the first active conversation circle 23.

In some embodiments, the user-interface 20 recognizes the existence of one or more second active conversation circles 30, as shown in the third region 26. In such cases, it is possible for one of the communicants to invite an entire second active conversation circle 30 to join the first active conversation circle 23, thus merging the two active conversation circles 23, 30. This typically involves making a gesture on the icon representing the second active conversation circle 30 in much the same way that one gestures on the icon representing a prospective communicant 28. Thus, broadly speaking, a prospective communicant can be a single person or a set of persons, with the set of persons being defined by the second active conversation circle 30.

In some embodiments, each member of the second active conversation circle 30 sees the invitation. In these embodiments, each member of the second active conversation circle 30 is empowered to act on behalf of other members, so that the first and second active conversation circle s 23, 30 are joined if any one member of the second active conversation circle 30 agrees to the merger of the first and second active conversation circles 23, 40.

In other embodiments, the user sees information identifying existing active conversation circles 30 and proactively asks to join one of those active conversation circles 30. This can be carried out by, for example, tapping on an icon representing an existing conversation circle 30 on the user-interface 20, or by dragging an icon representing the user into the icon representing an existing conversation circle 30 on the user-interface 20.

In some cases, members of an active conversation circle 23 may wish to maintain a low profile and to therefore avoid broadcasting their presence. In such cases, the software 19 can implement a privacy shield blocking the existence of the active conversation circle 23 from being made known. Alternatively, individuals may wish to avoid broadcasting their own individual presence, in which case the privacy shield extends only to the individual and not the entire active conversation circle 23.

In some cases, the same group of people will gather periodically at the same location. In these cases, it is useful to establish pre-defined conversation circles to avoid the tedium of manually adding everyone in this group to an active conversation circle 23 each time they gather, In such cases, the software 19 recognizes the presence of members of the pre-defined conversation circle and automatically adds them to the active conversation circle 23 once they are within range.

An apparatus as described herein for managing connectivity between users of a multi-user local network offers many advantages. For example, the user-interface 20 of such an apparatus, with its visual cues and its touch control for managing connections is intuitive. The apparatus also leverages the widespread acceptance of smart phones 18A-18C, as well as the Bluetooth capabilities already prevalent in smart phones 18A-18C.

Having described the invention, and a preferred embodiment thereof, what we claim as new, and secured by Letters Patent is:

1. An apparatus for managing communication between headsets, said apparatus comprising a first headset having a microphone, at least one earphone, and a wireless interface for voice and data communication with other headsets, said headset being distinguished from said other headsets by a first identification code, and a controller configured for recognizing a set of identification codes broadcast by said other headsets and causing said first headset to establish communication with headsets having identification codes selected from said set of identification codes.

2. The apparatus of claim 1, wherein said identification code is a permanent feature of said headset.

3. The apparatus of claim 1, wherein said controller is configured to provide said identification code to said headset.

4. The apparatus of claim 1, wherein the wireless interface is capable of periodically broadcasting information representative of its presence and status, and negotiating connections with other headsets.

5. The apparatus of claim 1, wherein said controller is further configured to receive said set of identification codes, to map at least some of said identification codes from said set of identification codes to persons, to display, based on said at least some of said identification codes, data representative of persons with which communication is available, to accept input defining a selection from said data representative of persons with which communication is available, a set of persons defining a conversation circle of persons with which communication is to be established, and to respond to receiving said data representative of identification codes defining said conversation circle by establishing communication with headsets identified by said identification codes.

6. The apparatus of claim 5, wherein said controller is configured to respond to receiving said data representative of identification codes defining said conversation circle by instructing said headset to establish communication with headsets identified by said identification codes.

7. The apparatus of claim 1, wherein said controller is further configured to display a user interface showing icons available for joining a conversation circle.

8. The apparatus of claim 7, wherein said controller is further configured to receive an input identifying one of said icons for inclusion in a conversation circle.

9. The apparatus of claim 7, wherein said icon represents a person.

10. The apparatus of claim 7, wherein said icon represents another conversation circle.

11. The apparatus of claim 7, wherein said controller is further configured for receiving instructions to solicit, from members of a conversation circle, permission to join said conversation circle.

12. The apparatus of claim 1, wherein said controller is further configured to cause suppression of broadcast of said identification code.

13. The apparatus of claim 1, wherein said controller is implemented as software on a touch-screen equipped portable device.

14. The apparatus of claim 13, wherein said software for implementing said controller is part of an operating system of said portable device.

15. The apparatus of claim 13, wherein said software for implementing said controller is an application executing on said portable device.

16. The apparatus of claim 1, wherein said headset is configured to establish communication with a touch-screen equipped portable device on which said controller is implemented.

17. The apparatus of claim 1, wherein said controller is implemented on a computer-readable medium that is partly in a touch-screen equipped portable device and partly in said headset.

18. The apparatus of claim 1, further comprising a touch-screen equipped portable device in communication with said headset, wherein said controller is implemented on said touch-screen equipped portable device.

19. The apparatus of claim 1, wherein said controller is implemented in said headset.

20. A method for managing wireless communication between headsets, said method comprising displaying information identifying headsets available for communication, receiving instructions identifying a subset of said headsets, and establishing communication with said subset of headsets to the exclusion of headsets not in said subset of headsets.

21. The method of claim 20, wherein said subset defines an active conversation circle.

22. The method of claim 21, further comprising issuing a request to join said active conversation circle, and receiving approval of said request.

23. The method of claim 21, further comprising suppressing broadcast of information identifying an active conversation circle to all but members of said active conversation circle.

24. The method of claim 20, further comprising suppressing broadcast of information identifying a headset.

25. A method for managing wireless communication between headsets, said method comprising establishing communication with a plurality of headsets, thereby defining a first conversation circle of headsets, receiving, from a first entity, a request to join said first conversation circle, approving said request, and establishing communication between said first entity and said plurality of headsets, thereby adding said first entity to said first conversation circle.

26. The method of claim 25, wherein said first entity comprises an individual headset.

27. The method of claim 25, wherein said first entity comprises a plurality of headsets that have established communication between each other, thereby forming a second conversation circle, and wherein establishing communication between said first entity and said plurality of headsets comprises merging said first and second conversation circles.

28. The method of claim 25, further comprising suppressing broadcast of information identifying a headset.

29. A manufacture comprising a non-transitory computer-readable medium having encoded thereon software for managing communication between headsets, each of which has a microphone, at least one earphone, and a wireless interface for voice communication with other headsets, each of said headsets being distinguished from other headsets by an identification code, said software comprising instructions for causing recognition of a set of identification codes broadcast by headsets from a set of headsets, and for causing establishment of duplex voice communication with a subset of said set of headsets, said subset consisting of headsets having identification codes selected from said set of identification codes.

30. The manufacture of claim 29, wherein at least part of said computer-readable medium is part of a touch-screen equipped portable device.

31. The manufacture of claim 29, wherein at least part of said computer-readable medium is part of a headset.
